(19) United States
(12) Patent Application Publication
(10) Pub. No.: US 2007/0078732 A1
(43) Pub. Date: Apr. 5, 2007

(54) Interactive information access system

(76) Inventors: C. Wayne Crolley, Bryant, AR (US); Michael Millard, Round Rock, TX (US)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 11/226,648

(22) Filed: Sep. 14, 2005

(51) Int. Cl. G06Q 30/00

(52) U.S. Cl. 705/27

(57) ABSTRACT

The present invention provides a system and method for interactively vending products and services related to a video program. The invention provides for a video program to be displayed on a user display platform, the video program comprising vendible objects for which information is available in an object information database. An object selection device, which may comprise a user display platform, is used for selecting an object related to the video program. A processor correlates this user-selected object with the vendible object from the database, which may then be available for purchase. A communication network may link the processor with the object information database. Interactive menus delivered to the user display platform present information related to the selected vendible object.

### FIELD OF THE INVENTION

The present invention relates in general to the field of interactively vending items through a video communication link.

### DESCRIPTION OF THE RELATED ART

Currently the ability to purchase items via television or other display devices is limited to shopping networks which direct customers to the phone or the internet to complete a transaction. Currently interactive TV and business conducted by means of interactive television, “T” commerce, are in the early stage of development and have not reached broad market adoption. Companies do strategically place products in television shows and movies. However, the ability to purchase the item is delayed until the consumer chooses to ‘shop’ for the item.

Television programming, as it is today, is somewhat two-dimensional allowing viewers to only select what they view by scanning channels to find a program of interest. Additionally, television advertisements can be intrusive and annoying to viewers. This is exemplified by the market adoption of “TiVo” like devices which allow users to bypass viewing the commercials. Viewers bypassing advertising means that advertising resources are used ineffectively.

U.S. Pat. No. 5,708,845 to Wistendahl, et al. discloses a system for allowing media content to be used in an interactive digital media (IDM) program has Frame Data for the media content and object mapping data (N Data) representing the frame addresses and display location coordinates for objects appearing in the media content. The N Data are maintained separately from the Frame Data for the media content, so that the media content can be kept intact without embedded codes and can be played back on any system. The IDM program has established linkages connecting the objects mapped by the N Data to other functions to be performed in conjunction with display of the media content. Selection of an object appearing in the media content with a pointer results in initiation of the interactive function. A broad base of existing non-interactive media content, such as movies, videos, advertising, and television programming can be converted to interactive digital media use. An authoring system for creating IDM programs has an object outlining tool and an object motion tracking tool for facilitating the generation of N Data. In a data storage disk, the Frame Data and the N Data are stored on separate sectors. In a network system, the object mapping data and IDM program are downloaded to a subscriber terminal and used in conjunction with presentation of the media content.

U.S. Pat. No. 6,490,580 to Dey, et al. discloses a method and device for selecting documents, such as Web pages or sites, for presentation to a user, in response to a user expression of interest, during the course of presentation to the user of a document, such as a video or audio selection, whose content varies with time. The method takes advantage of information retrieval techniques to select documents related to the portion of the temporal document in which the user has expressed interest. The method generates the search query to use to select documents by reference to text associated with the portion of the temporal document in which the user has expressed interest, as by using the closed caption test associated with the video, or by using speech recognition techniques. The method further uses a weighting function to weigh the terms used in the search query, depending on their temporal relationship to the user expression of interest. To conserve resources, the method does not transmit the closed caption or other synchronized multimedia information to the user, and obtains the necessary information about the temporal occurrence of terms in the temporal document from a database.

US Patent Application 20050160469 to Chiu, et al. discloses an interactive video generating system and method allow a user to establish link relations in the video content, so that an instantaneous broadcast according to desired selections of the user can be performed. Interactive link relations between the video files are achieved by means of block locations. With this system and method, more flexibility and selectivity are allowed to the user who no longer is limited to a unidirectional fixed video broadcast sequence.

There is a need for a marketing system that does not rely on advertising that inconveniently and without permission interrupts the viewer programming experience. There is a need to allow viewers to control when and to be able to decide what they purchase on an interactive basis.

### SUMMARY OF THE INVENTION

The present invention provides a system and method for interactively vending products and services related to a video program. The invention provides for a video program to be displayed on a user display platform, the video program comprising vendible objects for which information is available in an object information database. An object selection device, which may comprise a user display platform, is used for selecting an object related to the video program. A processor correlates this user-selected object with the vendible object from the database, which may then be available for purchase. A communication network may link the processor with the object information database. Interactive menus delivered to the user display platform present information related to the selected vendible object.

Examples of the more important features of the invention have been summarized (albeit rather broadly) in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE FIGURES

Features of the present invention will become apparent from the following detailed description considered in connection with the accompanying drawings disclosing embodiments of the present invention. It should be understood, however, that the drawings are designed for the purpose of illustration only and not as a definition of the limits of the invention. For a detailed understanding of the present invention, references should be made to the following detailed description of an exemplary embodiment, taken in conjunction with the accompanying drawings, in which like elements have been given like numerals in the drawings, wherein similar reference characters denote similar elements throughout the several views:

FIG. 1 illustrates a system for interactively vending items through a video communication link;

FIG. 2 illustrates a flow chart for a viewer to acquire information.

FIG. 3 illustrates a flow chart for vending objects to a viewer.

FIG. 4 illustrates how a database, interface and video program are related.

While the invention will be described in connection with its preferred embodiments, it will be understood that the invention is not limited thereto. It is intended to cover all alternatives, modifications, and equivalents that may be included within the spirit and scope of the invention, as defined by the appended claims.

### DETAILED DESCRIPTION OF THE INVENTION

In view of the above, the present invention through one or more of its various aspects and/or embodiments is presented to provide one or more advantages, such as those noted below. The present invention provides for vending objects related to video streams.

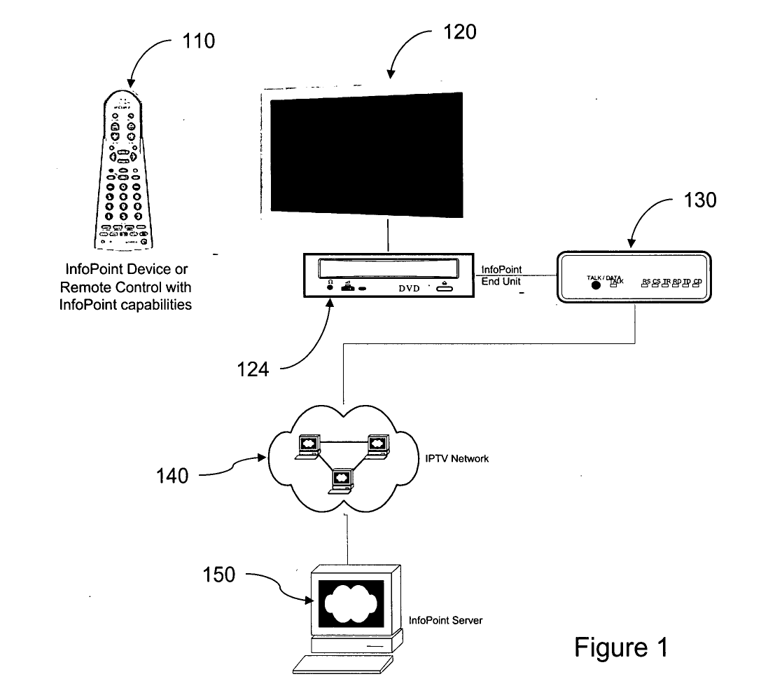

FIG. 1 shows a system provided by the present invention. The invention provides for interactively choosing objects or subjects in a data stream. The data stream may be a display presentation, like a television broadcast, movie or other video stream, and receiving more information about the objects. An object selection device 110 is provided for selecting objects in a display presentation delivered to a user display platform, such as display device 120. The display device 120 associated with a processor, which may comprise an object recognition engine 124 (ORE). The ORE 124 may be integrated into the display device in hardware or software or both. The ORE 124 correlates the objects from a database and video program with a displayed image. The display presentation delivered to display device 120 is associated with ORE 124 through a database 150 containing information related to the images in the display presentations. ORE 124 may be connected to database 150 through a network 140 by way of a communication device 130, for example a modem, broadband connection, private network, or the Internet. The database 150 contains information related to the images in the display presentations, including how viewers may purchase or acquire related services, products and other information. Alternatively, the database may reside on the same media as the source of the display presentation.

The ORE 124 coordinates the association of selected objects with the display presentation, including the presentation of menus related to services, products and other information. The objects that may be selected from the displayed images are indexed in the database 150. The indexing may be a time-index, a spatial-index or a combination of time with an image display index relative to the display presentation (TV program, movie, etc.) so that the database 150 may be synchronized directly with the display images.

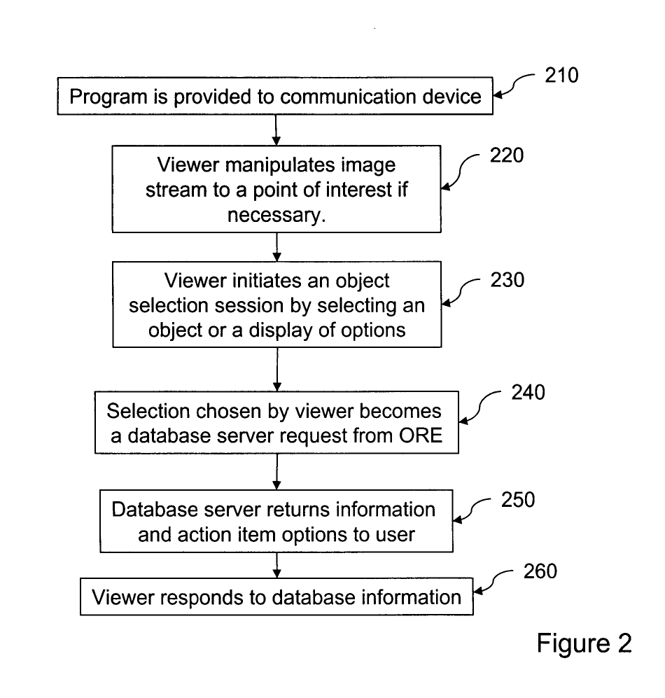

FIG. 2 illustrates a method provided by the present invention. A video program, which may be a news feature, an advertisement, a novella or any television show or movie, is provided to a video or image communication display device 210. Communication display devices include, but are not limited to televisions, telephones, movie theaters, and personal digital assistants (PDAs). As an option, a user/viewer may then manipulate the video image (pause, rewind, slow, etc) to obtain an image of a point or item of interest 220. At this point an object selection session may be initiated 230, if not initiated before. An object selection device 110 may enable direct object selection or a menu of options may be requested or activated. Alternatively, or in conjunction with an object selection device 110, the object selected and menu may be chosen by touching the screen. The menu may be present in the form or one or more of a device like a remote control or telephone or computer keypad, and it may work together with a menu image superimposed on a video screen. The menu provides selection choices related to a selected item or to obtain more information. When a user/viewer selects an object or menu item, a request is sent to a database or server 240 where information related to the images or requests are processed. Further information and options may then be returned to the user/viewer 250. The viewer may then respond to the database supplied information by initiating a purchase, requesting further information or terminating the information request session.

The invention is a system providing for interactively vending objects, whether products, services or information, using a video or image display device that is interfaced with an object information database. Object information in the database is preprogrammed so that it may be entered in the database prior to delivering program content to a user, such that the database is closely linked to the program images, and the subjects and/or objects displayed may be closely related and known beforehand.

A point and click methodology (like an infrared or laser pointer) or point and screen-touch are provided to conduct the exchange of goods or services and provide information to a user/viewer. A user may use an electronic device to point or touch to both manipulate and interact with image displays which would in turn provide supplementary information about the image. For example, a coat of one of the actors on a television show or movie may be chosen during an object selection session. Also, accommodations available in the geographic area shown in the program may be investigated and acquired. In the case of a product for sale, the information would include how much the product (a coat in this example) would cost, available sizes, the seller's address, shipping costs, expected time of delivery, payment type and amount charged. The user could then purchase the coat ‘through’ the interactive display program, for example a television show as the show is being aired. Other information could be provided as well which may include information about a particular actor such as name, age, and screen name, other movies/shows the actor has been in and provide options to purchase these same movies. In essence, the television becomes an advertising vehicle for products and services that can be purchased in real-time as a program is being broadcast, but the viewer controls whether and when to acquire items of interest related to the program without the interruption of commercials.

The present invention provides an interactive system by which viewers of television or other video stream can point a wireless device to a specific point on the screen to gain access to additional information concerning the person, place, or object currently displayed on the screen. Viewers watching a movie, television program, newscast, or any other content, can interact with the display to choose an object in the display and receive more information. Choosing an object may be by pointing or touching a wireless device, either a device built specifically for this purpose or special circuitry built for this function and integrated into a universal remote control, to a specific point on the screen indicating an area of interest which allows the viewer to obtain more information regarding the person, place or object at which they have just pointed. This invention may also include an apparatus or customized television screen which senses the specific area at which the viewer has pointed the device, and translates the exact location to the person, place or object currently displayed there.

The graphical image displayed on the screen may be associated with an object information database that spatially indexes the image and the associated X, Y coordinate which indicates the objects location on the screen. The record for this X, Y coordinate will also be associated in the database with an action, which may initiate a sub-routine related to an object in the vicinity of the coordinate or related to the subject of the program at that point. In conjunction with spatial-indexing the display presentation images, one or more time indexes may also be used. One time-indexing will be associated with the objects that are selectable from a display presentation image, another time-index is associated with information on the current state of the database. This information includes further current information for selectable objects and objects that are currently available for vending or for obtaining additional information about objects displayed on the screen.

The present invention may be used in a real-time mode and a pause mode, or with any manipulation of the content stream. The real-time mode may be used where video transmission streams are relatively long in duration, and where an image of an object is displayed for a period of time long enough for a viewer to respond interactively, pointing the object selection device to the area of the display and selecting a function. An example of a transmission like this would be a newscast, where shots of the newscaster are long and unmoving while they read through a series of stories.

In the pause mode, a viewer may freeze the display frame or slow the display of the content being displayed, and either point the object selection device to the area of interest in that scene, or, if the viewer missed the frame of interest, rewind the display transmission to a previous frame and select the area of interest in that frame using the object selection device. Additionally, the object selection device would enable selection of information for non-visual objects, such as the subject of the broadcast or the subject of the scene or news story being presented. The object selection device may be a mouse-type pointer or a device similar to a laser pointer, which would determine the area of interest within the frame currently displayed and display a menu related the selected object upon request.

An example is where a user/viewer is watching a news program 210 and is interested in a particular story on a specific topic, and is then interested in learning more about the subject of the news story. The viewer, using the object selection device or conventional means, may pause the live transmission and rewind the program to a specific point of interest 220. Many mechanisms exist today which allow viewers to pause live television.

Using the object selection device, the user/viewer initiates a request that an option menu be displayed 230 on the television screen, for example comprising a “Tell Me More” function. This may then initiate a session with a “Live Chat” interactive agent related to that selection or open a browser to a web page linked to the content currently displayed on the television screen.

Upon initiation of the “Tell Me More” request for further information 240, a request to a server or database location is initiated. The ORE 124 receives the request from the viewer, and communicates the request to a database 240 which contains pre-recorded footage associated with the news story currently frozen on the viewer's screen. The database initiates the transmission or available options or information in response to the request 250. For example, one of the options may be for the sending pre-recorded footage relating to the story back to the viewer's television or viewing device. An optional charge for the “Tell Me More” service may be added to the bill on the viewer's monthly statement.

As another example, a viewer acquires a movie from a service provider 210. The viewer is watching the movie, and is interested in the location at which the movie was filmed. The viewer, in conjunction with using the object selection device, pauses the movie and rewinds the program back to a specific point of interest 220. Using the object selection device, the viewer indicates an interest in the geographic location by selecting the background scenery of the film at a specific scene which initiates an information request 230. This may be accomplished, for example by any of: pointing a laser beam onto the display, pressing a button on the object selection device, touching the display device, or otherwise making an available menu selection. For the laser beam example, the ORE 124 in conjunction with the display 120 senses the point at which the laser beam is focused, and the coordinates of the display at which the beam was focused are transmitted, over a network 140 if necessary, to the database 150. The database 150 then returns pre-programmed information regarding the location at which the scene was filmed back to the viewer 250, which is then displayed on the screen 120, along with further options related to information for services or products 260. An optional charge for this request is recorded, and added to the monthly bill for this viewer.

In still another example, a viewer is watching television and sees a commercial for a particular product that the viewer is interested in purchasing. The viewer, using an object selection device 110 that comprises a laser pointer, points the beam transmitted out of the device to a box or menu option displayed on the screen which can be used to initiate the purchase of the product 230. The viewer then presses a button on the object selection device 110, initiating the purchase or requesting further information and options. When the viewer desires to initiate a purchase, the viewer may enter personal and financial information to affect the purchase. Alternatively, the viewer may be prompted to enter a pre-programmed security code if necessary for access, or the access permission may be previously encoded in software or hardware. If the viewer has an account for purchasing vendible objects set up through a service provider participating in the system of the present invention, the viewers account and shipping information may then be used to purchase the product. The product purchase order may be stored in the database 150, and/or forwarded to the provider company vending the product. An optional charge for the vending service, as well the charge for the purchased product may be recorded in the system database and added to the viewer's account. Likewise, the product provider may be charged by the service providing the interactive vending service.

The present invention provides for a personal computing platforms, like personal computers, PDAs and wireless telephones, where viewers connect to a service transmitting content and instead of using a separate object selection device, could request additional information about a person, place, or object by moving their mouse or other pointer over the object of which they would like more information, and clicking on that object during the video stream.

Other options for functionality similar to the “Tell Me More” service are that non-visual object related to the display presentation images may be offered. In this regard, alternatively to directly selecting an object in a video stream to request more information, initiating the present invention may bring up a pre-programmed on-screen menu of categories of available information regarding the video stream. For example, menu items regarding the display presentation can include information regarding the music, the time period of the subjects, the geographic areas, or any other subjects or objects that are intrinsic to the display presentation but are not amenable to selection by ‘point and click.’ Since a menu is also capable of encompassing display objects visually present in the display presentation, pointing devices and display coordinate sensing systems can be optional as part of a menu driven object selection system.

Additional services provided by the invention include ordering transcripts of programs, purchasing video and DVD copies of a program. Highly interactive services include voting related to programs and program content, rating television programs, submission of questions or comments to a live talk show or any of many other options providing instantaneous feedback from viewers.

The object selection device may be either a device which transmits a beam of light onto the screen, indicating an area of interest for the viewer or a track-ball device used to scroll a mouse pointer across the screen, moving the pointer over the area of interest, and clicking on the displayed object in order to bring up a menu or see the current additional information offered about the selected object. Additional services include capturing, printing or e-mailing selected frames within a transmission. Additionally, an alternative separate image of a selected object may appear on the display. For example, when an automobile is selected from a display presentation, an image from the manufacturer may appear along with further information, including price, size, company, where to find further information, how to initiate a purchase and payment arrangements.

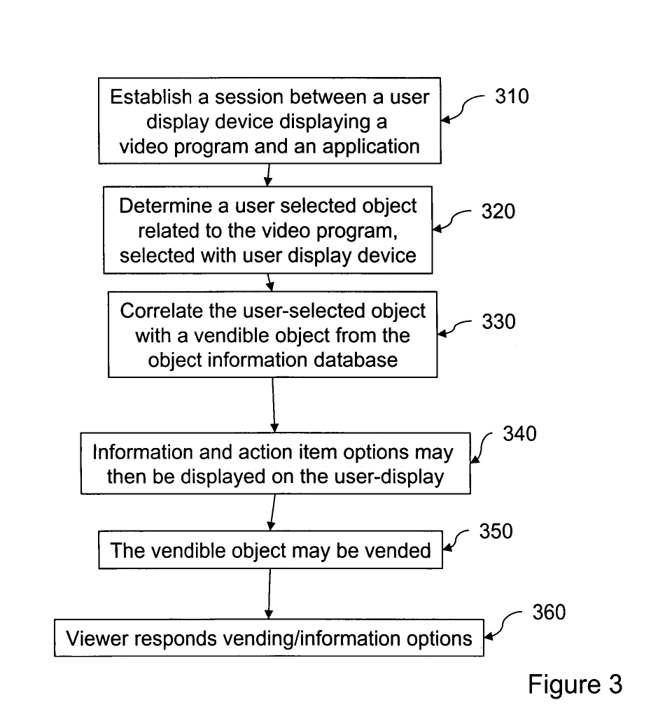

In one aspect the present invention provides a computer readable medium containing instructions that when executed by a computer perform a computerized method for interactively vending objects related to a video program using a user display device. As illustrated with the flowchart of FIG. 3, a computer establishes a session between a user display device and at least one application 310. A user-selected object related to a video program displayed on the display device 320 is correlated 330 with a vendible object related to the video program, wherein the vendible object is in an object information database. Information and vending options 340 related to vending 350 the vendible object from the database may be displayed on the user display device, which may be in menu form. At least one application is linked with the object information database. The session may be established with a user-identity manager facility, perhaps requiring a code or password for access, so that account information is pre-programmed, and product and service ordering along with financial information already linked when the session is initiated. An interactive menu may be displayed on the user display device with information related to the user-selected object and correlated vendible objects. The method provides for a device for manipulating the video program as well as a user object selection device used in conjunction with the user display device.

In another aspect the present invention provides a set of application program interfaces (software interfaces) embodied on a computer readable medium for execution on a computer in conjunction with an application program that correlates a user-selected object related to a video program with a vendible object in an object information database. A first interface receives input when a user selects an object from the video program on the user display. A second interface receives input when a session with the object information database comprising vendible object information is established. A third interface receives input to correlate the user-selected object with the vendible object information in an object information database. The vendible object may be related to the video program. Other application interfaces are provided for: i) vending the vendible object in an object information database, ii) manipulating the video program on the user display, iii) a user-selection device for selecting a user selected object using the user display; iv) an interactive menu on the user display, and v) access to a user account based on a user identity.

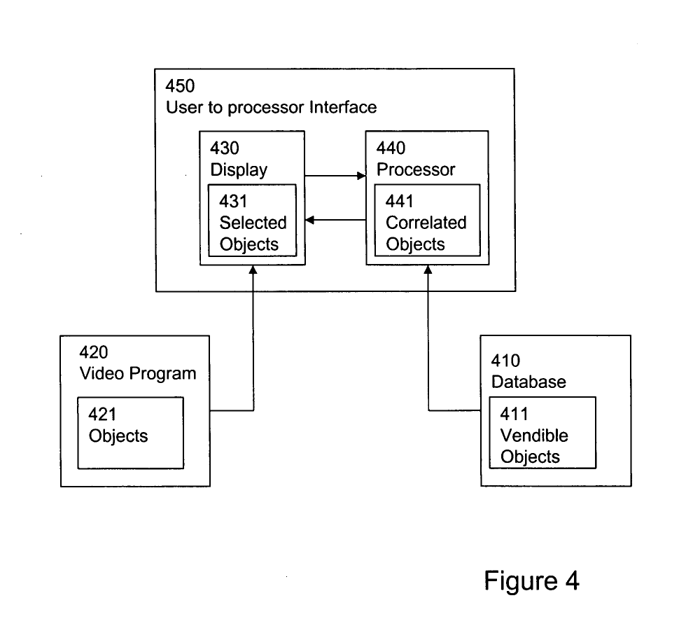

In another aspect illustrated in FIG. 4 the present invention provides a system for vending objects related to a video program. The system comprises an object information database 410 of vendible objects 411 related to a video program 420. A user-to-processor interface 450, which may comprise a user-display platform 430 and processor 440, is provided for selecting a user-selected object related to the video program 420, and for presenting vending options for a vendible object. A processor 440 (which may be an ORE 124) is configured to correlate the user-selected object 421 related to the video program 420 with the database of vendible objects 411, thereby determining correlated objects 441. A processor to database interface may include a communication network 140. The object information database may contain a processor for processing, storing and forwarding purchase orders of vendible objects. The user-to-processor interface 450 may work with a device for manipulating the video program. The interface 450 may also comprise an interactive menu displayed on the user display device, and contain options for vending the vendible objects in the object information database.

Accordingly, while embodiments of the present invention have been shown and described, it is to be understood that many changes and modifications may be made thereunto without departing from the spirit and scope of the invention as defined in the appended claims.

The present invention described herein is well adapted to carry out the objects and attain the ends and advantages mentioned, as well as others inherent therein. While various embodiments of the invention have been given for purposes of disclosure, numerous changes exist in the details of procedures for accomplishing the desired results. Various modifications will be apparent to those skilled in the art. It is intended that all variations within the scope and spirit of the appended claims be embraced by the foregoing disclosure.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

What is claimed is:

1. A set of application program interfaces embodied on a computer readable medium for execution on a computer in conjunction with an application program that correlates a user-selected object related to a video program with a vendible object in an object information database, comprising:
(a) a first interface that receives an input from a user for determining a user-selected object related to a video program, the user-selected object selected with a user display;
(b) a second interface that receives an input for establishing a session with an object information database comprising vendible object information; and
(c) a third interface that receives an input for correlating the user-selected object related to a video program with the vendible object information in an object information database.

2. The set of application program interfaces of claim 1 further comprising a fourth interface that receives an input for vending the vendible object in an object information database.

3. The set of application program interfaces of claim 1 wherein the vendible object in an object information database is related to the video program.

4. The set of application program interfaces of claim 1 further comprising a fifth interface that receives an input for manipulating the video program on the user display.

5. The set of application program interfaces of claim 1 further comprising a sixth interface that receives an input for a user-selection device for selecting a user selected object using the user display.

6. The set of application program interfaces of claim 1 further comprising a seventh interface that receives an input related to an interactive menu on the user display.

7. The set of application program interfaces of claim 1 further comprising an eighth interface that receives an input related to access to a user account based on a user identity.

8. A system for vending objects related to a video program comprising:
(a) an object information database comprising information for a vendible object related to a video program;
(b) a user-to-processor interface for selecting, on a user display device,
i) a user-selected object related to the video program, and
ii) for presenting vending options for the vendible object; and
(c) a processor configured to correlate the user-selected object related to the video program with the vendible object in the object information database.

9. The system of claim 8 further comprising a communication network interface linking the processor and the object information database.

10. The system of claim 8 wherein the object information database further comprises a processor for processing purchase orders of vendible objects.

11. The system of claim 8 wherein the user-to-processor interface further comprises a device for manipulating the video program.

12. The system of claim 8 wherein the user-to-processor interface further comprises an interactive menu displayed on the user display device.

13. The system of claim 12 wherein the interactive menu further comprises options for vending the vendible object in the object information database.

14. The system of claim 8 further comprising a user object selection device used in conjunction with the user display device.

15. A computer readable medium containing instructions that when executed by a computer perform a computerized method for interactively vending objects with a user display device comprising:
(a) establishing a global session between a user display device and at least one application to correlate a user-selected object related to a video program displayed on the display device with a vendible object related to the video program, wherein the vendible object is in an object information database;
(b) accessing the user-selected object information wherein the user-selected object is selected using the user display device;
(c) correlating the user-selected object with the vendible object; and
(d) vending the vendible object related to the video program.

16. The medium of claim 15, wherein the method further comprises a communication network linking the at least one application with the object information database.

17. The medium of claim 15, wherein the method further comprises establishing the global session by establishing a user session with a user-identity manager.

18. The medium of claim 15, wherein the method further comprises an interactive menu displayed on the user display device with information related to the user-selected object.

19. The medium of claim 15, wherein the method further comprises a device for manipulating the video program on the user display device.

20. The medium of claim 15, wherein the method further comprises a user object selection device used in conjunction with the user display device.
